(19) United States
(12) Patent Application Publication
(10) Pub. No.: US 2007/0116397 A1
(43) Pub. Date: May 24, 2007

(54) Unitized bearing assembly and method of assembling the same

(75) Inventors: Praveen M. Pauskar, Canton, OH (US); Martin D. Pierce, Navarre, OH (US); James J. Piccari, Massillon, OH (US); Wayne V. Denny JR., Alliance, OH (US); David E. Zehner, Uniontown, OH (US); Steven A. Kuhn, East Canton, OH (US); Richard H. Miller, Canton, OH (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: The Timken Company

(21) Appl. No.: 11/283,160

(22) Filed: Nov. 18, 2005

(51) Int. Cl. F16C 13/00

(52) U.S. Cl. 384/544

(57) ABSTRACT

A wheel end or other assembly for facilitating rotation about an axis includes a tubular housing, a spindle that extends into the housing, and a double row antifriction bearing between the housing and spindle. The bearing includes at least one separate inner race that fits over the spindle, with the axial position of that race determining the setting for the bearing. Preferably, a spacer fits around the spindle between the inner race and a backing element. The assembly is unitized by deforming the end of the spindle outwardly against the end of the separate inner race with the deformation being sufficient to drive the inner race toward the backing element and collapse the spacer, if present. The deformation of the end of the spindle continues until bearing produces a torque that reflects a desired preload in the bearing.

### CROSS-REFERENCE TO RELATED APPLICATIONS

Not Applicable.

### STATEMENT REGARDING FEDERALLY SPONSORED RESEARCH

Not Applicable.

### BACKGROUND OF THE INVENTION

This invention relates in general to bearings and more particularly to a unitized bearing assembly and method of assembling the same.

Automobiles and light trucks of current manufacture contain many components that are acquired in packaged form from outside suppliers. The packaged components reduce the time required to assemble automotive vehicles and further improve the quality of the vehicles by eliminating critical adjustments from the assembly line. So called “wheel ends” represent one type of packaged component that has facilitated the assembly of automotive vehicles.

The typical wheel end has a housing that is bolted against a steering knuckle or other suspension upright, a hub provided with a flange to which a road wheel is attached and also a spindle that projects from the flange into the housing, and an antifriction bearing located between the housing and the hub spindle to enable the hub to rotate in the housing with minimal friction. In an advanced form of the wheel end the inboard end of the spindle is formed over the end of the bearing to permanently unitize the wheel end.

Actually, the bearing has rolling elements, such as tapered rollers, organized in two rows and raceways along which the rolling elements roll. The raceways and rolling elements of the outboard row are oriented opposite to the raceways and rolling elements of the inboard to enable the bearing to transfer thrust loads in both axial directions as well as radial loads. Moreover, the inner raceway for inboard row, that is to say the raceway that is around the spindle at the inboard end of the spindle, is on a race that is formed separately from the hub spindle, so the axial position of this race determines the setting for the entire bearing, and that setting should preferably provide a light preload in the bearing. Once the inboard inner race is installed over the spindle, the end for the spindle is deformed outwardly against the end of the race to permanently capture the bearing, at least in the unitized form of the wheel end. In order for the inboard inner race to assume the correct position on the hub spindle and thereby provide the bearing with the correct setting, that inner race must be machined with considerable precision. This consumes time and increases the cost of the wheel end.

U.S. Pat. No. 6,443,622 discloses a rotary forming process for upsetting the end of the hub spindle to utilize a wheel end, but requires a precisely machined inner race.

U.S. Pat. No. 6,532,666 discloses a more sophisticated process, that also requires precision machining. U.S. Pat. No. 6,460,423 discloses a process for verifying preload in the unified bearing, but requires complex equipment and a long cycle time.

### BRIEF DESCRIPTION OF THE SEVERAL VIEWS OF THE DRAWINGS

FIG. 1 is a sectional view of a bearing assembly in the form of a wheel end assembled in accordance with the present invention;

FIG. 2 is an elevational view of a rotary forming machine used to assemble the wheel end;

FIGS. 3A, B, C, D are fragmentary sectional views, in sequence, showing the steps of assembling the wheel end;

FIG. 4 illustrates circlips that may be used for the spacer in the wheel end;

FIG. 5 illustrates collapsible sleeves that may be used for the spacer in the wheel end;

FIG. 6 is a sectional view of a modified wheel end;

FIG. 7 is a fragmentary sectional view of another modified wheel end that utilizes angular contact ball bearings;

FIG. 8 is a fragmentary sectional view of still another modified wheel end that utilizes angular contact ball bearings.

FIG. 9 is a sectional view of another modified wheel end that further has the capacity to monitor angular velocity;

FIG. 10 shows fragmentary sectional views of the elongated spacers suitable for the modified wheel end of FIG. 9, both before and after deformation between opposing crushing surfaces; and

FIG. 11 shows fragmentary sectional views of spacers formed integral with a backing element that is in turn formed integral with the hub spindle.

### DETAILED DESCRIPTION OF THE PREFERRED EMBODIMENT

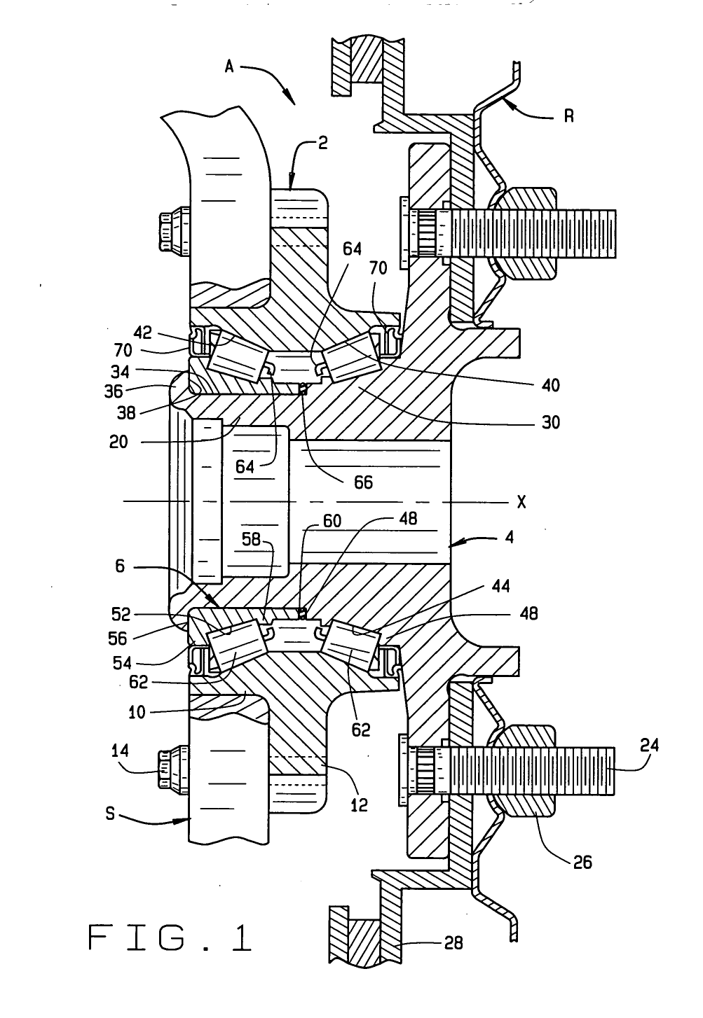

Referring to the drawings, a wheel end A (FIG. 1), which is in essence a bearing assembly, couples a road wheel R to a suspension system component S of an automobile, and enables the road wheel B to rotate about an axis X and to transfer both radial loads and thrust loads in both axial directions between the wheel B and suspension system component S. If the road wheel R steers the vehicle, the suspension system component S takes the form of a steering knuckle. If it does not steer, the suspension system component S is a simple suspension upright. The wheel end A includes a housing 2 that is bolted to the suspension system component S and provides an outer member, a hub 4 that provides an inner member to which the road wheel B is attached, and a bearing 6 located between the housing 2 and hub 4 to enable the latter to rotate with respect to the former about the axis X with minimal friction. The wheel end A is unitized permanently with its bearing 6 in a slight preload.

The housing 2, which is formed from high carbon steel, preferably as a forging, includes (FIG. 1) a generally cylindrical body 10, which is tubular, and a triangular or rectangular flange 12 projecting radially from the body 10 generally midway between the ends of the body 10. The inboard segment of the body 10 is received in the suspension system component C such that the flange 12 comes against the component S, to which the flange 12 is secured with bolts 14. Thus, the wheel end A is attached to the suspension system component C at the flange 12 of its housing 2.

The hub 4, which is also formed from high-carbon steel, preferably as a forging, includes (FIG. 1) a spindle 20, which extends through the tubular body 10 of the housing 2, and a flange 22 that is formed integral with the spindle 20 at the outboard end of the spindle 20. The flange 22 is fitted with lug bolts 24 over which lug nuts 26 thread to secure a brake disk 28 and the road wheel B to the hub 4.

The spindle 20 merges with the flange 22 at an enlarged region 30 that leads out to a cylindrical bearing seat 34 that in turn leads out to a formed end 36. The formed end 36 is directed outwardly away from the axis X and provides an inside face 38 that is squared off with respect to the axis X and is presented toward the enlarged region 30.

The bearing 6 lies between the spindle 20 of the hub 4 and the housing 2 and enables the hub 4 to rotate relative to the housing 2 about the axis X. It includes (FIG. 1) two outer raceways 40 and 42 formed on the interior surface of the tubular body 10 for the housing 2, the former being outboard and the latter being inboard. The two raceways 40 and 42 taper downwardly toward each other so that they have their least diameters where they are closest, generally midway between the ends of the housing 2. Along the raceways 40 and 42 the housing 2 is hardened by induction heating and quenching. Apart from the two outer raceways 40 and 52, the bearing 6 also includes an inner raceway 44 and thrust rib 46 that are on the enlarged region 30 of the spindle 20. The raceway 44 lies at the outboard position and faces the outboard outer raceway 40, tapering in the same direction downwardly to the center of the housing 2. The thrust rib 46 extends along the large end of the raceway 44. Both along the raceway 44 and the thrust rib 46 the hub is case hardened by induction heating and quenching. Beyond the opposite small end of the raceway 44, the bearing 6 has a shoulder 48 that faces away from the flange 22. It is presented toward the inside face 38 of the formed end 36 and enables the end of the enlarged region 30 to serve as a backing element.

The bearing 6 also includes (FIG. 1) an initially separate inner race in the form of a cone 50 that fits over the bearing seat 34 of the spindle 20 with an interference fit. It is preferably formed from case hardened bearing steel and includes a raceway 52 that is presented outwardly toward the inboard outer raceway 42 on the housing 2 and tapers in the same direction, downwardly toward the middle of the housing 2. At the large end of its raceway 52 the cone 50 has a thrust rib 54 that leads out to a back face 56 that is squared off with respect to the axis X. At the small end of its raceway 52 the cone 50 has a retaining rib 58 that leads out to a cone front face 60 that is also squared off with respect to the axis X.

Completing the bearing 6 are rolling elements in the form of tapered rollers 62 organized in two rows, one located between and contacting the outboard raceways 40 and 44 and the other located between and contacting the inboard raceways 42 and 52.

The rollers 62 of each row are on apex. Thus, the conical envelopes in which the outboard raceways 42 and 46 and outboard rollers 62 lie have their apices at a common point along the axis, and likewise the conical envelopes in which the inboard raceways 42 and 50 and the inboard rollers 62 lie have their apices at another common point along the axis X. The rollers 62 of each row are separated by a cage 64 that maintains the proper spacing between the rollers 62 and further retains them in place around their respective inner raceways 44 and 52 in the absence of the housing 2.

The cone 50 fits over the bearing seat 34 of the spindle 20 with an interference fit and there lies captured between the enlarged region 30 of the spindle 20 and the formed end 36 of the spindle 20. Indeed, its back face 56 bears against the inside face 38 of the formed end 36, while its front face 60 is presented toward, yet spaced from, the shoulder 48 at the end of the enlarged region 30 of the spindle 20.

Preferably, the space between the shoulder 48 and the back face 56 of the cone 50 is occupied by a collapsed spacer 66 that bears against both and extends circumferentially around essentially the entire bearing seat 34. The spacer 66 is preferably formed from a soft metal. In any event, the substance from which the spacer 66 is formed together with its configuration are such that the spacer 66, when compressed between the shoulder 32 of the spindle 20 and the front face 60 of the cone 50, will plastically deform under a force less than that required to plastically deform either the enlarged region 30 of the hub spindle 20 or the cone 50.

The housing 2 and its ends contain seals 70 which close the ends of the bearing 6 and prevent contaminants from entering the bearing 6 while retaining a lubricant in the bearing 6.

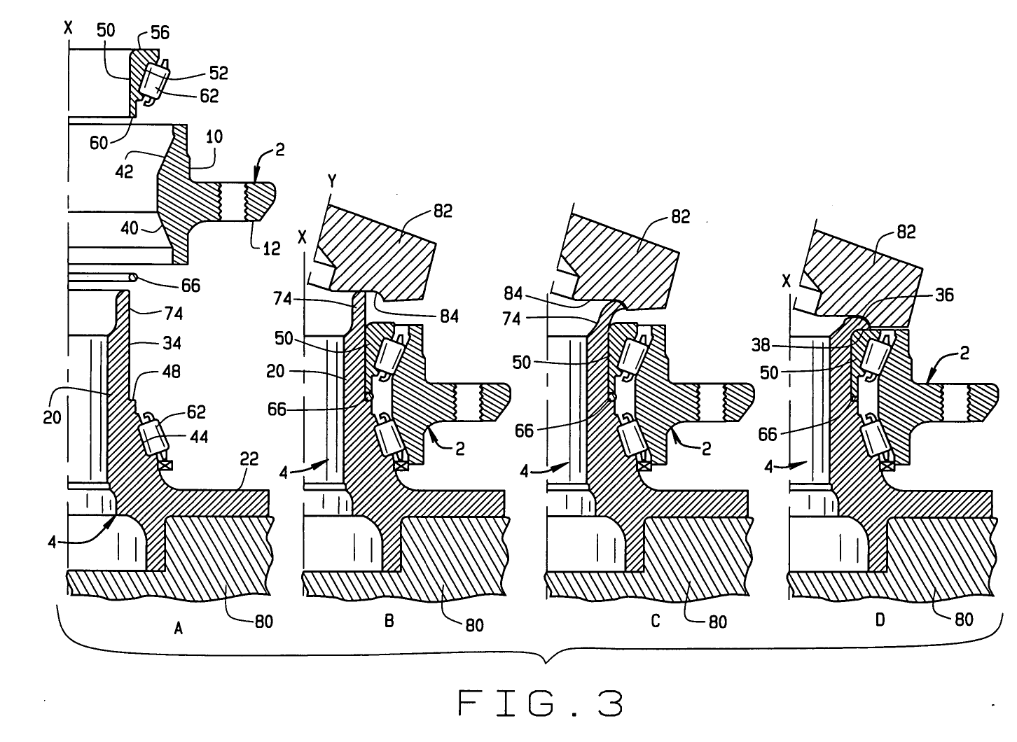

Initially, the hub 4 does not have the formed end 36 at the inboard end of its spindle 2. Instead, it is manufactured with a deformable end 74 (FIG. 3) that forms an extension of the bearing seat 34, it having an outside diameter that is the same as the outside diameter of the bearing seat 34. Thus, the outwardly presented surface of the deformable end 74 and the bearing seat 34 are indistinguishable. Moreover, as manufactured, the spacer 66 is somewhat thicker than the thickness it assumes in the completed wheel end A, that is to say its axial dimension is initially greater.

To assemble the wheel end A, the inboard row of rollers 62 is installed around the inboard inner raceway 44 that is on the enlarged region 30 of the hub spindle 20, with those rollers 62 being retained by the cage 64 for the inboard row (FIG. 3A).

Likewise, the outboard seal 70 is fitted to the thrust rib 46 on the enlarged region 30.

Thereupon, the housing 2 is passed over the spindle 20 and advanced to seat its outboard raceway 40 against the rollers 62 of the outboard row, which rollers 62 are also seated against the inner raceway 44 (FIG. 3B). Next the spacer 66 in its original configuration is installed over the spindle 20 and brought against the shoulder 48 on the enlarged region 30. After the spacer 66 is in place the cone 50, with its complement of outboard rollers 62 around its raceway 52, is forced over the bearing seat 34 until its front face 60 comes against the spacer 66 (FIG. 3B). In this condition the deformable end 74 projects beyond the back face 56 of the cone 50, and the bearing 6 possesses a good measure of end play. As such clearances exist within the bearing 6.

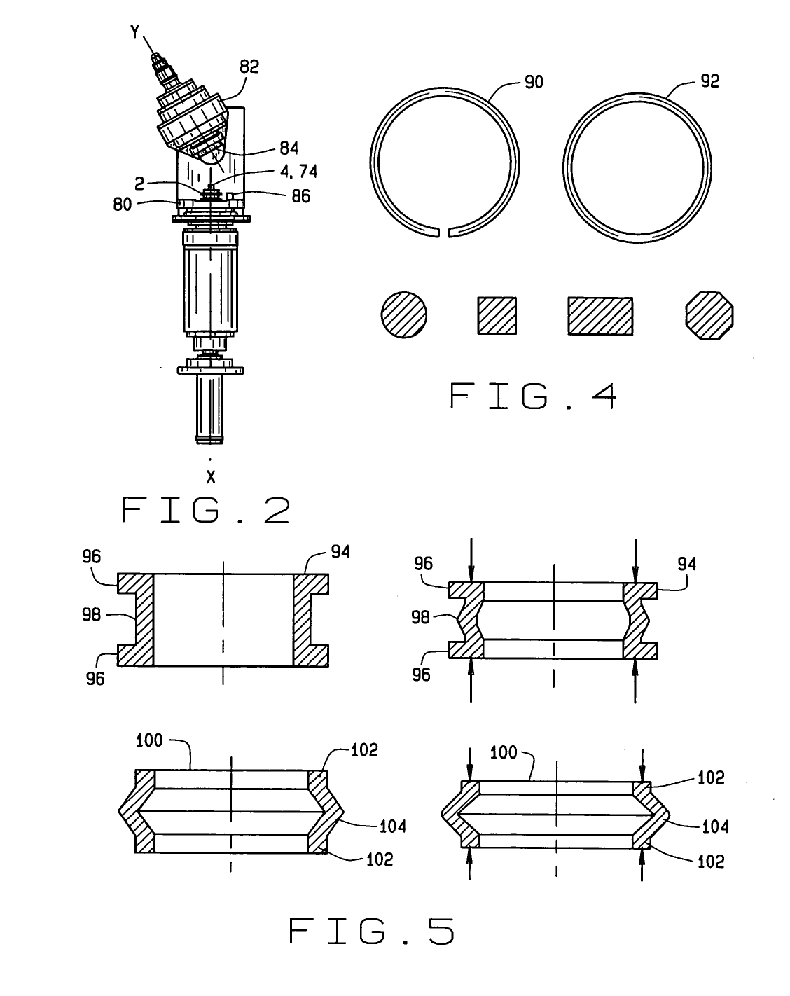

Once the cone 50 is in place around the spindle 20, the partially assembled wheel end A is brought to a rotary forming machine D (FIG. 2) including a table 80 configured to support the hub 4 with its spindle 20 projecting away from the region support and a forming tool 82 having a contoured face that is presented toward the table 80. The hub 4 seats against the table 80 such that it is held fast and cannot rotate relative to the table 80. Yet the table 80 rotates under power about the axis X of the spindle 20, thus rotating the entire hub 4. The table 80 further has the capacity to translate to and fro along the axis X. The forming tool 82 rotates under power about an axis Y that is oblique to the axis X. The housing 2 is retained against rotation by a device 86 that measures torque transferred through the bearing 6 to the retained housing 2. U.S. Pat. No. 6,443,622 discloses the forming machine D and its operation in more detail, and is incorporated in this disclosure by reference.

With the table 80 and the hub 4 rotating about the axis X, the hub 4 is advanced toward the forming tool 82 which also rotates. The advance brings the deformable end 74 against the contoured face 84 of the rotating forming tool 82 (FIG. 3B). The table 80 forces the deformable end 74 against the face 84, and the face 84 deforms the end 74 outwardly away from the axis X (FIG. 3C). The deformation of the end 74 continues, bringing the end 74 over the back face 56 of the cone 50. With continued advancement of the table 80, the end 74 bears against the back face 56 of the cone 50 and drives the entire cone 50 toward the enlarged region 30 and flange 22 of the hub 4 (FIG. 3D). The spacer 66 resists the advance, but even so collapses under the force applied. But neither the shoulder 48 on the enlarged region 30 of the spindle 20, nor the cone 50 are deformed. The resistance offered by the spacer 66 enables the deformable end 74 to transform into the formed end 36 with a large and flat contact area between the formed end 36 and the cone back face 56, that is to say it provides the deformed end with the inside face 38 at which it bears against the cone back face 56. The advancement of the table 80 continues slowly at this juncture, until the restraining device 86 that is coupled to the housing 2 measures a prescribed torque that correlates with a desired preload for the bearing 6. At that time the advancement of the table 80 ceases, but the table 80 continues to rotate as does the forming tool 82. In short, the process enters a dwell phase. If the torque remains at the prescribed magnitude during dwell phase, the table 80 is withdrawn, the wheel end A is removed from it, and the outboard seal 70 is installed on the housing 2.

Actually, the wheel end A may be assembled without the spacer 66. In that event, the space otherwise occupied by the spacer 66 becomes a void. The geometry of the tapered rollers 62 and the tapered raceways 40, 42 and 44, 52 that they contact prevent the front face 60 of the cone 50 from bearing against the shoulder 48 on the enlarged region 30 of the hub spindle 20. The torque transferred from the rotating hub 4 through the tapered rollers 62 to the housing 2 and measured at the restraining device 86 determines when the formed end 36 on the spindle 20 has assumed the correct position. In other words, a prescribed torque, which is determine empirically, reflects a desired preload for the bearing 6. The presence of the spacer 66, however, facilitates establishing a good contact area between the back face 56 of the inboard cone 50 and the formed end 36. Moreover, the spacer 66 imparts an extra measure of stiffness to the spindle 20 of the hub 4, so that the spindle 20 will experience less flexure when heavy radial loads are transferred through the wheel end A.

The spacer 66 before deformation between the shoulder 48 and cone front face 60 may assume various configurations. It may take the form of a simple circlip 90 (FIG. 4) having open ends or it may be a closed circlip 92 formed by welding its ends together. The circlips 90 and 92 may be formed from wire of circular cross section, square cross section, rectangular cross section, or polygonal cross section (FIG. 4). Other cross-sectional configurations will suffice for the spacer 66—indeed, there are infinite different shapes that will work. The wire may be ductile steel, aluminum, copper, brass, or any material that can be deformed. The spacer 66 may also take the form of a sleeve 94 (FIG. 5) having flanges 96 at its ends and a cylindrical intervening section 98 which deforms outwardly when the flanges 96 are forced together under a compressive force applied through the shoulder 48 and the cone back face 56. Likewise, the spacer 66 may take the form of a sleeve 100 (FIG. 5) having axially directed ends 102 and intervening portion 104 that bows outwardly. When the ends 102 are forced together, the intervening portion 104 bows still farther outwardly. Indeed, any sleeve that will deform under a compressive load will suffice. Irrespective of the material from which any of the spacers 66 are formed, the spacer 66, when subjected to a compressive force between the shoulder 48 and the cone front face 60 should undergo a plastic deformation before either the enlarged region 30, including its shoulder 48, and the cone 50 deform plastically.

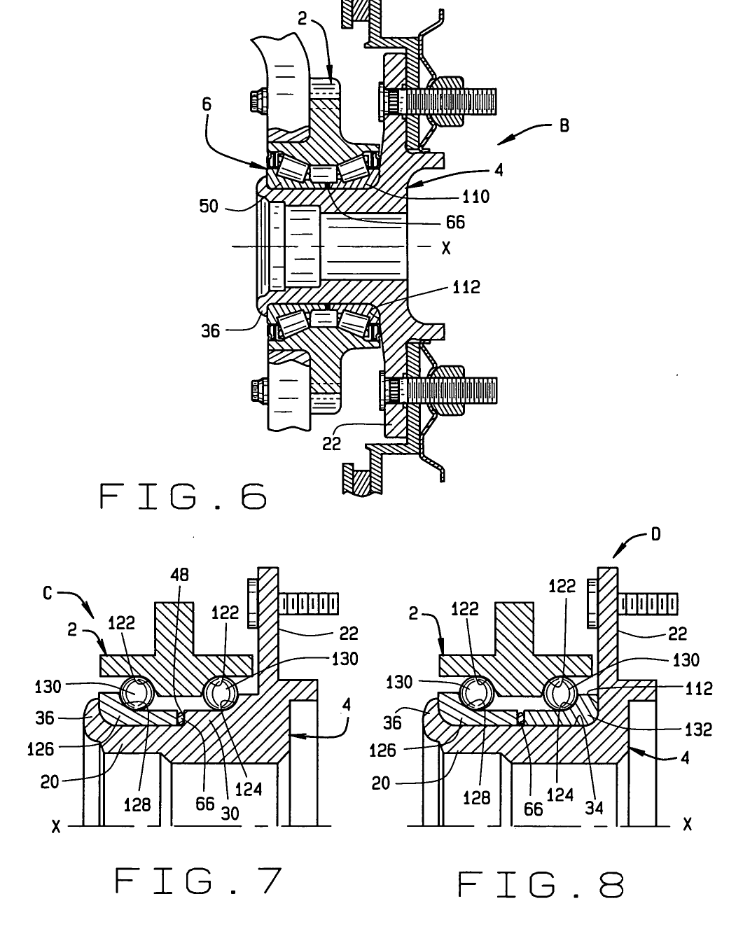

In lieu of forming the outboard inner raceway 44 on an integral segment of the spindle 20—basically a cone integrated into the spindle 20—a modified wheel end B (FIG. 6) has the outboard inner raceway 44 on a separate outboard cone 110. To accommodate the cone 110, the bearing seat 34 extends farther toward the hub flange 22 and terminates at a shoulder 112 located adjacent to the flange 22. The outboard cone 110 fits over the extended bearing seat 34 with an interference fit and bears against the shoulder 112 at its back face 56. The front face 60 of the outboard cone 110 functions as a backing element or shoulder against which the spacer 66 is collapsed and thus corresponds to the shoulder 48 on the enlarged region 30 of wheel end A.

In lieu of the tapered roller bearing 6 between the housing 2 and spindle 4, another modified wheel end C (FIG. 7) utilizes, angular contact ball bearings 120. The wheel end C has arcuate outer raceways 122 in the housing 2, an arcuate inner raceway 124 on the enlarged region 30 of the spindle 4, an inboard inner race 126 having another arcuate inner raceway 128, and balls 130 arranged in two rows around the inner raceways 124 and 128 and of course within the outer raceways 122. The spacer 66 fits between the inboard race 126 and the shoulder 48 on the enlarged region 30.

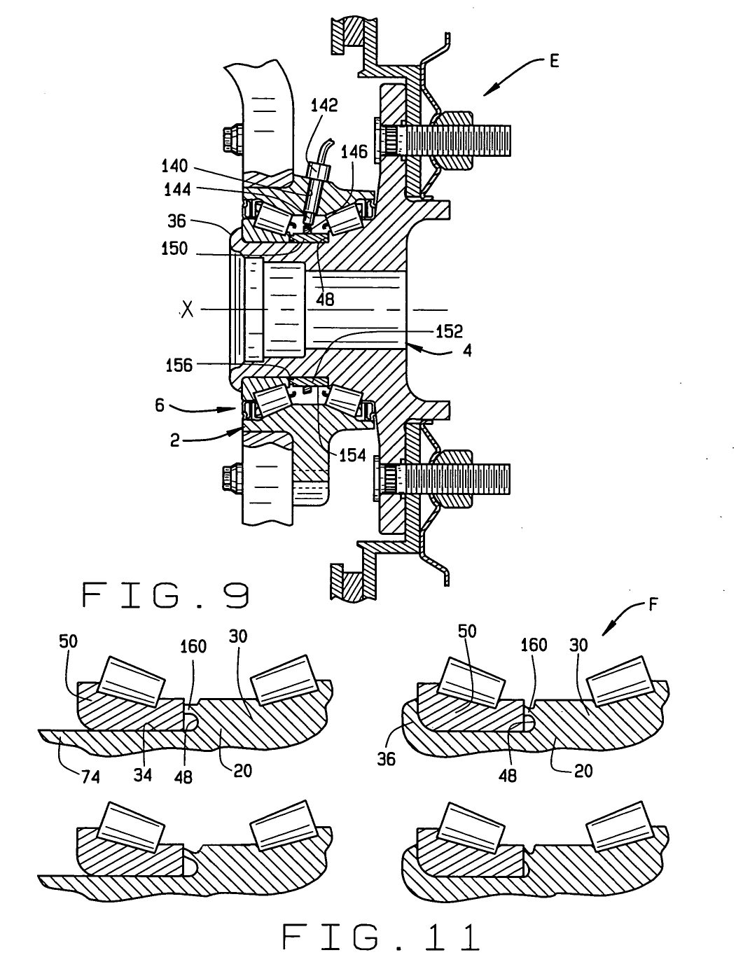

A wheel end D (FIG. 8) has the inboard inner raceway 124 on a separate inner race 132, in which event the bearing seat 34 need be extended to a shoulder 112. The spacer 66 fits between the front faces of the two inner races 126 and 132. Indeed, the end of the outboard race 132 forms a backing element or shoulder against which the spacer 66 is deformed.

The tapered outer raceways 40 and 42 may be on separate outer races, called cups, forced into the housing 2 or even on a single outer race called a double cup.

Likewise the arcuate outer raceways 122 may be on separate races fitted to the housing 2 or on a single outer race.

Still another modified wheel end E (FIG. 9) has the capability of sensing the angular velocity of the hub 4 so as to facilitate the operation of an antilock brake system and a traction control system. To this end, the housing 2 is provided with a bore 140 that opens into its interior between the small ends of the tapered outer raceways 40. The bore 140 lies oblique to the axis X and opens out of the housing 2 at a location that is slightly offset from that face of the flange 12 that is against the suspension system component S. The oblique bore 140 contains a sensor 142 having at its inner end a probe 144 that is presented toward and in close proximity to the peripheral surface of a target wheel 144 that rotates with the hub 4 between the small ends of the tapered rollers 62 or other rolling elements. The probe 144 produces an electrical signal that reflects the angular velocity of the target wheel 146 and the hub 4.

The target wheel 146 is carried by an extended spacer 150 that fits over the bearing seat 34 with a slight interference fit and lies snuggly between the shoulder 48 on the enlarged region 30 and the front face 60 of the inboard cone 50. It has an annular body 152 provided with cylindrical exterior surface 154 over which the target wheel 144 fits again with an interference fit. One end of the body 152 provides a face that lies perpendicular to the axis X, and that end the body 152 bears against the shoulder 48. At its other end the annular body 152 merges into a deformable portion 156 that is, at least, initially thinner than the body 152. The deformable portion 156 bears against the front face 60 of the cone 50, and is deformed as a consequence of the compressive force applied to the cone 50 as the deformable end 74 of the hub spindle 20 is converted into the formed end 36. When the spacer 150 is compressed between the enlarged region 30 of the spindle 20 and the cone 50, the deformable portion 156 of the spacer 150 should deform plastically before the enlarged region 30, including its shoulder 48, or the cone 50, including its front face 60, undergo any plastic deformation. Likewise, it should plastically deform before the annular body 152 of the spacer 150 deforms plastically.

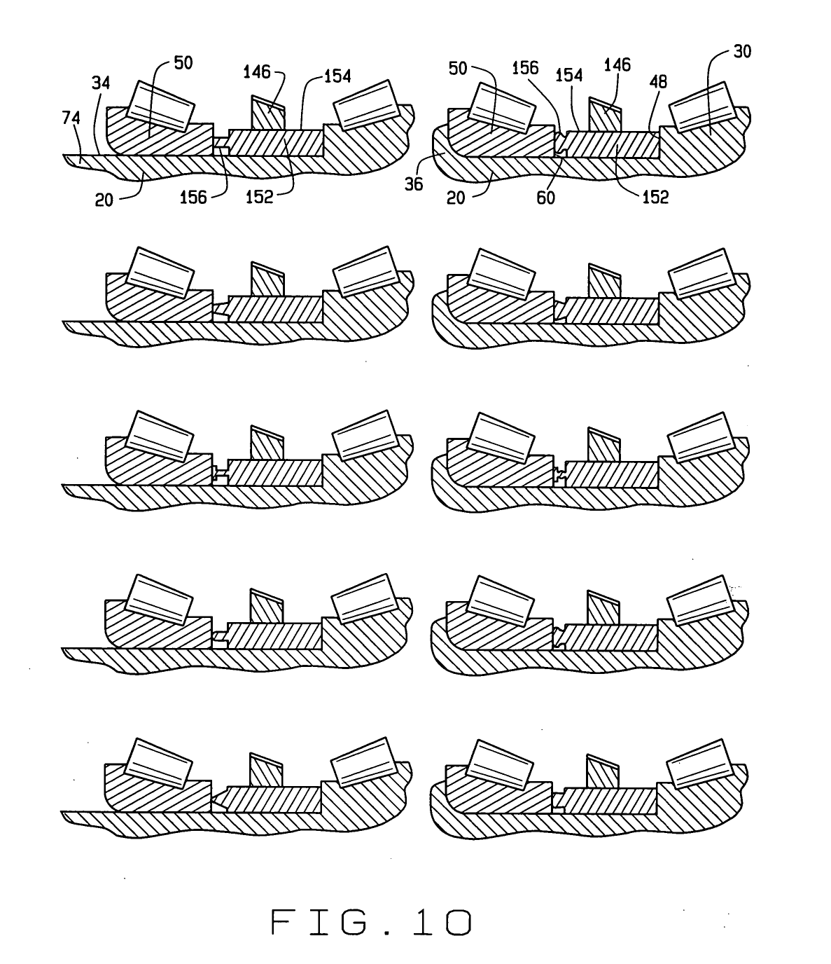

The deformable portion 156 may in cross-section initially be trapezoidal with its smallest end presented away from the annular body 152 or it may be rectangular (FIG. 10). Then again it may be T-shaped in cross-section and oriented such that the cross-piece of the T is spaced from the annular body 152 so that the leg of the T experiences the deformation when the collapsing force is applied. Also, the end of an otherwise rectangular deformable end 156 may be rounded. The deformable end 156 may also have a triangular cross-section with a rounded apex presented such that the force is applied at a rounded apex. Other cross-sectional configurations are available for the deformable portion 156. Irrespective of its configuration, the deformable portion 156 should deform plastically before either the cone 50 or the enlarged region 30 of the spindle 4 deform plastically and likewise before the main body 152 deforms plastically.

Of course, an outboard cone 110 may be substituted for the enlarged portion 30 of the spindle 4, with the front face 60 of that cone 110 serving as the shoulder. 48, so that the spacer 140 is compressed between the front faces 60 of the two cones 50 and 110.

In yet another modified wheel end F (FIG. 11), which in most respects is the same as the wheel end A, a spacer 160 is formed as a integral part of the enlarged region 30 of the spindle 20. The spacer 16 projects from the shoulder 48 of the enlarged region 30. Beyond the shoulder 48 the spacer bears against the front face 60 of the inboard cone 50. Being an integral part of the enlarged region 30, the spacer 160 is formed from the same material as the hub 4, which is high carbon steel. And while high carbon steel may be case hardened in a heat treatment, the hub 4 is only case hardened along the raceway 44 and thrust rib 46 of the enlarged region 30. To this end, the enlarged region 30 is induction heated along the raceway 44 and thrust rib 46 and then quenched, thus, leaving the raceway 30 and thrust rib 46 harder than the remainder of the hub 4. As a consequence, the spacer 160 will deform when subjected to a compressive face applied through the cone 50. After all, the spacer 160 possesses less cross-sectional area than the shoulder 48 and backing element of the enlarged region 30, which lie immediately behind it. Being either formed from high carbon steel that is through hardened or preferably from low carbon steel that is case carburized and then hardened at its exterior surfaces, including its front face 60, the inboard cone 50 does not deform as the spacer 160 is crushed.

The spacer 160 may be initially, that is before deformation, directed axially essentially parallel to the axis X. When deformed, it tends to spread radially inwardly and outwardly. On the other hand, the spacer may be initially directed slightly outwardly from the shoulder 48, somewhat oblique to the axis X. When deformed, it tends to spread both inwardly and outwardly, but perhaps farther outwardly than inwardly. Other configurations are available for the integral spacer 160.

The races may also be those of deep groove ball bearings or spherical roller bearings, both of which have raceways that are inclined with respect to the axis X to carry thrust loads. Furthermore, the bearing 6 may assume a hybrid form including rolling elements of one configuration in the inboard row and rolling elements of another configuration in the outboard row. For example, the inboard row may contain tapered rollers and function as a single row tapered roller bearing and the outboard row may contain balls that function as a single row angular contact ball bearing, or vice versa.

The housing 2, spindle 20, and bearing 6 need not be part of a wheel end, but may serve other purposes where facilitation of rotation about an axis X is required. In other words, the bearing assembly embodied in the wheel end A may have other applications which could require modification of the housing 2 or spindle 4 or both.

1. A process for assembling a bearing assembly that facilitates rotation about an axis and includes an outer member that carries first and second raceways that are inclined in opposite directions with respect to the axis, an inner member including a spindle that carries a first inner raceway that is inclined with respect to the axis in the same direction as the first outer raceway and a backing element located axially beyond the first inner raceway, first rolling elements configured for arrangement in a row between the first outer and inner raceways, a separate inner race configured to fit over the spindle and having a second inner raceway inclined with respect to the axis in the same direction as the second outer raceway, and second rolling elements configured for arrangement in a row between the second raceways, said process comprising:
installing the outer member over the inner member with the first rolling elements interposed between the first outer and inner raceways;
locating a collapsible spacer over the spindle and opposite the backing element carried by the spindle;
installing the inner race over the spindle with the second rolling elements being interposed between the second outer and inner raceways such that one end of the inner race is opposite the spacer and such that a segment of the spindle projects beyond the opposite end of the inner race in the provision of a deformable end; and
deforming the deformable end of the spindle against that end of the inner race beyond which the spindle projects to create a formed end that captures the inner race on the spindle, with the deformation exerting enough force on the inner race to collapse the spacer between the backing element and the inner race.

2. The process according to claim 1 wherein the deformation of the deformable end comprises: rotating the inner member and its spindle, and bringing the spindle and a rotating forming tool together with enough force to deform the deformable end outwardly away from the axis and transform it into the formed end.

3. The processes according to claim 2 and further comprising:
restraining the outer member as the inner member rotates;
measuring the torque applied to the outer member through the rolling elements as the inner member rotates; and
terminating the deformation when the torque reaches a prescribed magnitude reflecting a desired preload.

4. The process according to claim 1 wherein the separate inner race at one end has a back face through which thrust loads are transferred and a front face at its opposite end; and wherein the front face is presented toward the spacer.

5. The process according to claim 1 wherein the spacer deforms under less force than the force required to plastically deform the backing element or the separate inner race.

6. The process according to claim 1 wherein the backing element includes a shoulder and the spacer 160 is initially detached from the shoulder.

7. The process according to claim 1 wherein the first inner raceway and the backing element are formed integral with the spindle, and the spacer is formed integral with the backing element.

8. A process for assembling a wheel end that couples a road wheel to a suspension system component of an automotive vehicle and enables the wheel to rotate about an axis, with the wheel end being assembled from;
a housing configured for securement to the suspension system component and having an outboard end and an inboard end;
a hub having a flange located opposite the outboard end of the housing and a spindle projecting from the flange and having a deformable end remote from the flange, and
a bearing including:
outboard and inboard outer raceways in the housing where they are presented inwardly toward the axis and are inclined with respect to the axis downwardly toward each other;
an outboard inner raceway carried by the spindle and presented outwardly and inclined with respect to the axis in the same direction as the outboard outer raceway;
a backing element located axially beyond the small end of the outboard inner raceway;
a separate inner race configured to fit over the spindle and having an inboard inner raceway that is presented outwardly and is inclined in the same direction as the inboard outer race, the inner race also having at one end a back face through which thrust loads are transferred and a front face at its opposite end;
outboard rolling elements located around the outboard inner raceway,
inboard rolling elements located around the inner race at its inboard inner raceway;
said process comprising:
installing the housing over the spindle of the hub such that the outboard outer raceway is around the outboard rolling elements and around the outboard inner raceway with the outboard rolling elements located between the outboard raceways;
installing the inner race over the spindle with its front face presented toward the abutment face and with a spacer interposed between the front face and the backing element;
deforming the deformable end outwardly away from the axis and over the back face of the inner race;
continuing the deformation such that the deformed end comes against the back face of the inner race and drives the inner race toward the shoulder and collapses the spacer; and
terminating the deformation when the bearing reaches a desired preload.

9. The process according to claim 8 wherein the spindle rotates relative to the housing when the deformable end is deformed; wherein the torque transferred through the bearing is monitored; and wherein the deformation of the spindle end is terminated when the torque reaches a prescribed magnitude reflecting the desired preload.

10. The process according to claim 8 wherein the spacer deforms under the application of a force less than that required to deform either the backing element or the inner race.

11. The process according to claim 8 wherein the outboard inner race and the backing element are formed on the spindle.

12. The process according to claim 8 wherein the outboard inner race and the backing element are on a separate outboard race that fits over the spindle.

13. The process according to claim 8 wherein the housing contains a speed sensor and the spacer carries a target wheel that is monitored by the speed sensor; and wherein the spacer is collapsed in a region remote from the target wheel.

14. The process according to claim 13 wherein the spacer has an annular body and a deformable portion at one end; and wherein the target wheel is carried by the annular body.

15. A bearing assembly for facilitating rotation about an axis, said bearing assembly comprising:
a tubular housing located around the axis;
a spindle projected into the housing and having a bearing seat and a formed end that is directed outwardly away from the axis and bearing seat as an integral part of the spindle;
a bearing located between the spindle and the housing to enable one to rotate relative to the other, the bearing including:
outboard and inboard outer raceways carried by the housing and presented inwardly toward the axis, the outer raceways being inclined with respect to the axis in opposite directions;
an inboard inner raceway carried by the spindle and presented outwardly toward the outboard outer raceway and inclined in the same direction as the outboard outer raceway;
a backing element presented toward the formed end;
a separate inner race located around the bearing seat and having an inboard inner raceway that is presented outwardly toward the inboard outer raceway and is inclined in the same direction as the inboard outer raceway, the inner race also having a back face that is against the formed end and a front face that is presented toward the abutment face;
outboard rolling elements located in a row between the outboard raceways; and
inboard rolling elements located in a row between the inboard raceways; and
a spacer located between the front face of the inner race and the backing element, the spacer being collapsed as a consequence of the inner race having been driven toward the backing element during the creation of the formed end.

16. An assembly according to claim 15 wherein the bearing is in preload.

17. An assembly according to claim 16 wherein the outboard inner raceway and backing element are formed on and integral with the spindle.

18. An assembly according to claim 17 wherein the spacer is formed integral with the backing element.

19. An assembly according to claim 16 wherein the outboard inner raceway and backing element are on another inner race that fits over the bearing seat of the spindle.

20. An assembly according to claim 16 wherein the spacer is formed from a material that deforms plastically under force more readily than the backing element or the inner race deforms plastically.

21. A wheel end including the assembly of claim 16; and wherein the spindle forms part of a hub that also includes a flange at the end of the spindle remote from the formed end.

22. An assembly according to claim 16 wherein the raceways are tapered and the rolling elements are tapered rollers.

23. An assembly according to claim 16 wherein the raceways are arcuate and the rolling elements are balls.

24. An assembly according to claim 16 wherein the tubular housing contains a speed sensor; and wherein the spacer carries a target wheel that is monitored by the speed sensor.

25. A process for assembling a bearing assembly that facilitates rotation about an axis and includes an outer member that carries first and second raceways that are inclined in opposite directions with respect to the axis, an inner member including a spindle that carries a first inner raceway that is inclined with respect to the axis in the same direction as the first outer raceway, first rolling elements configured for arrangement in a row between the first outer and inner raceways, a separate inner race configured to fit over the spindle and having a second inner raceway inclined with respect to the axis in the same direction as the second outer raceway, and second rolling elements configured for arrangement in a row between the second raceways, said process comprising:
installing the outer member over the inner member with the first rolling elements interposed between the first outer and inner raceways;
installing the inner race over the spindle with the second rolling elements being interposed between the second outer and inner raceways;
effecting relative rotation between the outer and inner members; and
during the relative rotation deforming the deformable end of the spindle behind that end of the inner race beyond which the spindle projects to create a formed end that captures the inner race on the spindle, with the deformation exerting-enough force on the inner race to place the rolling elements in preload;
monitoring the torque transferred through the rolling elements from one member to the other member during the relative rotation; and
terminating the deformation when the torque reaches a prescribed magnitude reflecting a desired preload.

26. The process according to claim 25 wherein effecting relative rotation comprises rotating the inner member relative to the outer member; and wherein deforming the deformable end comprises bringing the spindle and a rotating forming tool together with enough force to deform the deformable end outwardly away from the axis and transform it into the formed end.

27. The processes according to claim 26 wherein monitoring the torque comprises restraining the outer member as the inner member rotates; and measuring the torque applied to the outer member through the rolling elements as the inner member rotates.
